(19) United States
(12) Patent Application Publication
(10) Pub. No.: US 2003/0044206 A1
(43) Pub. Date: Mar. 6, 2003

(54) Performance sensing cleaning device

(75) Inventor: Kenneth J. Brown, Rochester, NY (US)

Correspondence Address: Lawrence P. Kessler, Patent Department, NexPress Solutions LLC, 1447 St. Paul Street, Rochester, NY, 14653-7103, US

(73) Assignee: NexPress Solutions LLC

(21) Appl. No.: 10/080,009

(22) Filed: Feb. 21, 2002

Related U.S. Application Data
(60) Provisional application No. 60/317,392, filed on Sep. 5, 2001.

(51) Int. Cl. G03G 21/00

(52) U.S. Cl. 399/353

(57) ABSTRACT

A method and structure for an image processing apparatus includes an image transfer substrate, a cleaner adjacent the substrate and sensors within the cleaner is disclosed. The cleaner removes contaminates from the substrate and sensors within the cleaner. The sensors detect a position of the cleaner with respect to the substrate, a proper rotation of components within the substrate, and a proper bias of the components. The components include a fiber brush, a detone roller, and an auger.

### BACKGROUND OF THE INVENTION

1. Field of the Invention

The present invention relates in general to a performance rating device in a cleaning assembly, and more particularly to an apparatus that monitors the performance of a cleaner for an electrophotographic image processing device by monitoring whether all rotational and biasing devices are operating properly, and whether the cleaner is in correct geometric orientation with respect to the substrate being cleaned.

2. Description of the Related Art

In a typical commercial reproduction apparatus (electrostatographic copier/duplicators, printers, or the like), a latent image charge pattern is formed on a uniformly charged dielectric member. Pigmented marking particles are attracted to the latent image charge pattern to develop such images on the dielectric member. A receiver member is then brought into contact with the dielectric member. An electric field, such as this is provided by a corona charger or an electrically biased roller, is applied to transfer the marking particle developed image to the receiver member from the dielectric member. After transfer, the receiver member bearing the transferred image is separated from the dielectric member and transported away from the dielectric member to a fuser apparatus at a downstream location. There, the image is fixed to the receiver member by heat and/or pressure from the fuser apparatus to form a permanent reproduction thereon.

However, not all of the marking particles are transferred to the printing material and some remain upon the belts or drum. Therefore, a cleaning assembly is commonly used to remove the excess marking particles. The cleaning assembly usually includes an electrostatic cleaning brush (detone roller), a skive, and a receptacle to hold the excess marking particles (waste toner material). The devices within the cleaner assembly generally rotate to remove waste particles.

It is important to determine whether the cleaning assembly is operating properly to avoid contamination of the entire image processing apparatus. However, it is difficult to measure the performance of the cleaning apparatus. For example, conventional cleaner assembly performance measurements are made using a sophisticated sensor which detects the number of particles remaining on a substrate after the substrate has passed by the cleaner assembly. In conventional structures, measurement of cleaning effectiveness by use of transmission or reflection densitometry of the substrate has a number of disadvantages: First the sensor(s) themselves can be contaminated and a source of reliability degradation. Also these devices are generally only effective at the detection of catastrophic failures due to the low sensitivity of these devices. Further, these devices are generally of high cost, and use of these devices do not provide any additional information as to the root cause of the cleaning failure. The invention senses the important attributes of the cleaning function and is much more effective than conventional systems that simply measure the effectiveness of the cleaning function.

### SUMMARY OF THE INVENTION

In view of the foregoing and other problems, disadvantages, and drawbacks of the conventional cleaner assembly the present invention has been devised, and it is an object of the present invention, to provide a structure and method for an improved cleaner assembly.

In order to attain the object suggested above, there is provided, according to one aspect of the invention, an image processing apparatus that includes an image transfer substrate, a cleaner adjacent the substrate, and sensors within the cleaner. The cleaner removes contaminates from the substrate. The sensors detect a position of the cleaner with respect to the substrate, a proper rotation of components within the substrate, and a proper bias of the components. If the sensors detect an improper position, an improper rotation, or an improper bias, the cleaner is rated unacceptable.

The components include a fiber brush, a detone roller, and an auger. The fiber brush and the detone roller are biased to attract the contaminates. The invention includes a skive adapted to remove the contaminates from said detone roller. The auger transports the contaminates to a storage receptacle after the skive removes the contaminates from the detone roller. The sensors eliminate the need for sensors on the substrate.

The invention provides an image transfer substrate and places a cleaner adjacent the substrate with sensors within the cleaner. The invention removes contaminates from the substrate with the cleaner. The invention detects, with the sensors, a relative position of the cleaner with respect to the substrate. The invention also detects a proper rotation of components with respect to the substrate. Further, the invention detects a proper bias of the components. The cleaner is rated unacceptable if the sensors detect an improper position, an improper rotation, or an improper bias. The invention also detects whether components, including a fiber brush, a detone roller, and an auger, are rotating properly. The fiber brush and the detone roller are biased to attract the contaminates.

Therefore, the invention checks the cleaning function by sensing the operation of the subsystems (e.g., release, transport, scavenge, convey, collection, etc.) within the cleaner assembly. Thus, the invention checks the rotation of the brush, detone roller, auger(s), etc. In addition, the invention checks for brush and detone bias voltage. Further, a sensor is used to detect proper spacing and orientation between the cleaner apparatus and the substrate. By observing the foregoing features, the invention does not require sophisticated sensors on the substrate to measure the effectiveness of the actual cleaning function.

### BRIEF DESCRIPTION OF THE DRAWINGS

The foregoing and other objects, aspects and advantages will be better understood from the following detailed description of preferred embodiment of the invention with reference to the drawings, in which:

FIG. 1 is a schematic drawing showing the fundamental components of most cleaner assemblies.

FIGS. 2A and 2B are side elevation schematics of a color printer apparatus utilizing a cleaning apparatus of the invention.

FIG. 3 is a side elevation schematic showing in greater detail the cleaning apparatus forming a part of the apparatus of FIG. 2.

FIG. 4 is a chart showing the construction of different elements within the cleaner assembly.

FIG. 5 is a chart showing the different features that the invention monitors to rate the performance of the cleaner assembly.

### DETAILED DESCRIPTION OF PREFERRED EMBODIMENTS OF THE INVENTION

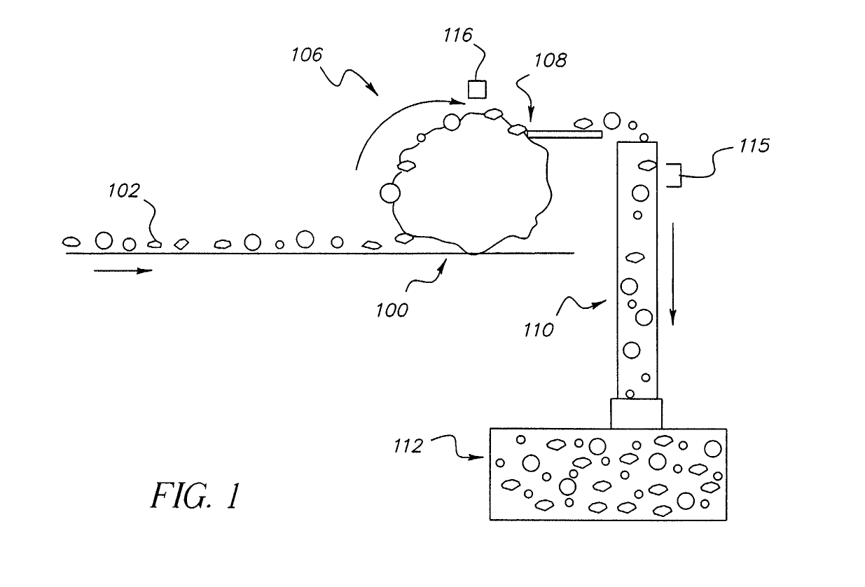

The invention overcomes the problems discussed above regarding the difficulty of rating the performance of the cleaner assembly. FIG. 1 illustrates a conceptual drawing of the different elements within a cleaner assembly. The substrate 100 that is to be cleaned is illustrated as having particles 102 thereon. These particles 102 are undesirable contamination on the substrate 100 and should be removed.

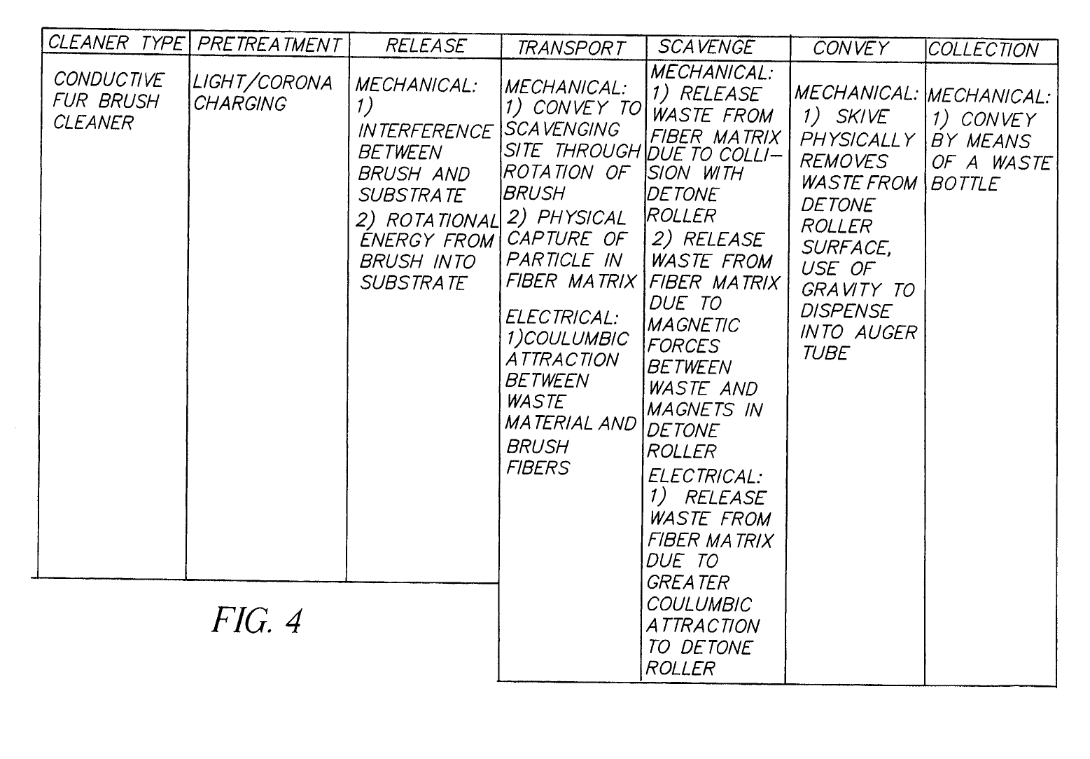

As shown in FIG. 4, there are a number of different cleaner types that are used, such as a conductive brush cleaner. As is also shown in FIG. 4, the pretreatment can comprise the application of light or a corona charging procedure.

The charged particles are transferred from the substrate into a collection media 106. The waste particles 102 are collected by the collection media 106 because of physical and electrical characteristics. For example, the collection media 106 can comprise a fiber brush in combination with vacuum, a magnetic brush, or a conductive fur brush. In a preferred embodiment, the collection media 106 rotates as indicated by the arrow in FIG. 1. As shown in FIG. 4, the release from the substrate to the collection media 106 occurs because of mechanical energy being transferred to the waste particles from rotation of the collection media 106. In addition, the waste particles 102 are electrically attracted to the collection media 106. Therefore, the collection media 106 performs the function of releasing the waste particles 120 from the substrate 100, and transporting the particles 102 as the collection media 106 rotates (which is performed using mechanical and electrical forces, see FIG. 4).

The invention scavenges the particles transferred from the collection media 106. The effectiveness of the collection media at entraining the waste particles decreases as the amount of collected waste increases. Therefore, a scavenging system 108 (such as an electrically biased detone roller in conjunction with a mechanical skive blade) is used to remove the waste particles 102 from the collection media 106. The scavenging system 108 causes the waste particles 102 to be directed into a tube, such as an auger tube 110. The auger tube 110 transports the waste particles 102 into a collection chamber 112.

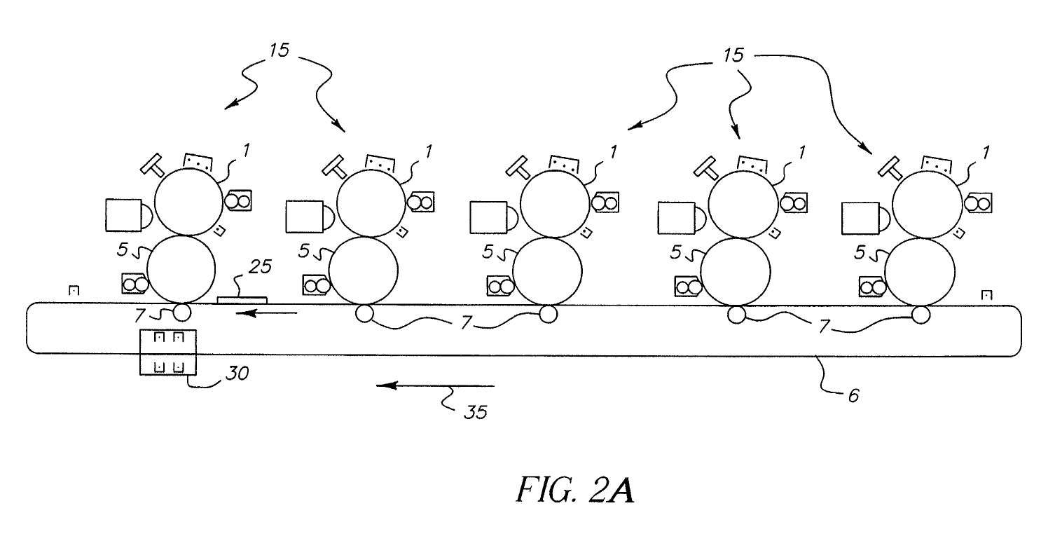

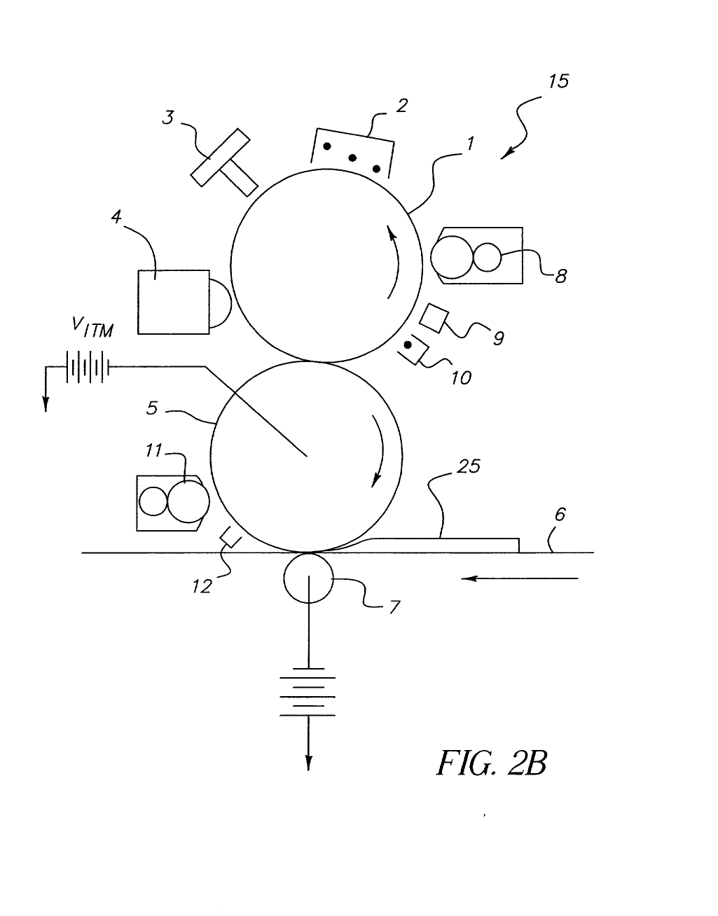

FIG. 2A illustrates an apparatus in which the invention may be used. A conveyor 6 is drivable to move a receiving sheet 25 (e.g., paper, plastic, etc.) past a series of stations 15. One of the stations 15 is shown in greater detail in FIG. 2B.

With the invention, a primary image member (for example a photoconductive drum) 1 within each imaging station 15 is initially charged by a primary charging station 2. This charge is then modified by a printhead 3 (e.g., LED printhead) to create an electrostatic image on the primary image member 1. A development station 4 deposits toner on the primary image member 1 to form a toner image corresponding to the color of toner in each individual imaging station 15. The toner image is electrostatically transferred from the primary image member 1 to an intermediate transfer member, for example, intermediate transfer roller or drum 5. While both of the image transfer members 2, 5 are shown as drums, as would be known by one ordinarily skilled in the art, these could also comprise belts or similar image transfer surfaces. The drums 2, 5 are used in these examples to simplify the explanation of the invention; however, the invention is not limited to drums, but instead, is applicable to all similar structures/surfaces.

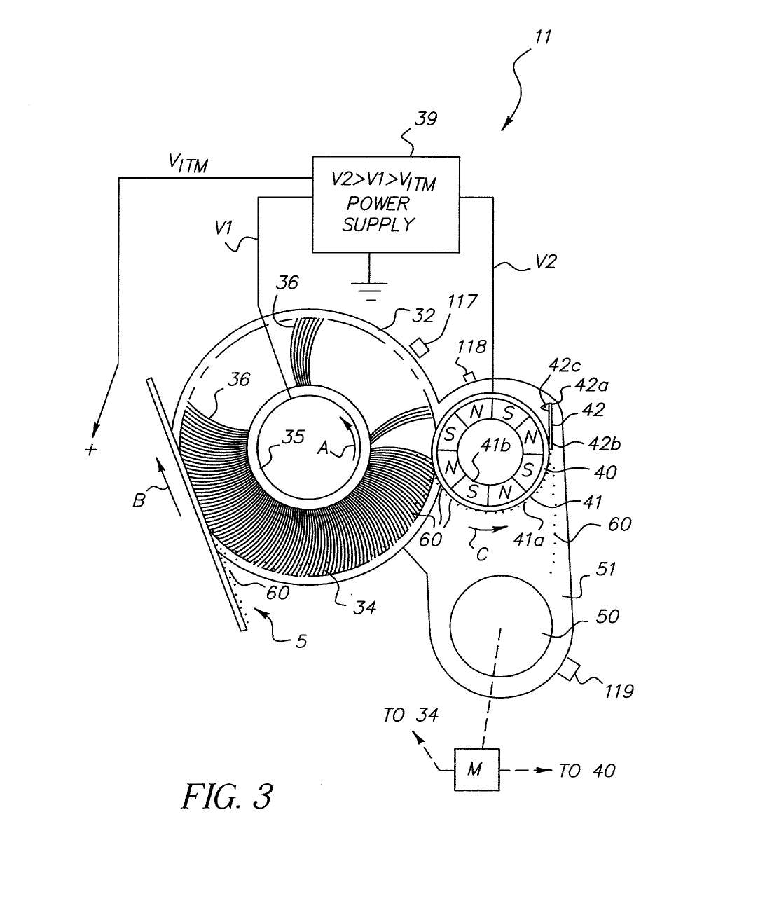

After the charged toner is transferred to the intermediate transfer drum 5, there still remains some waste toner particles that need to be removed from the primary image member 1. The invention uses a pre-cleaning erase light emitting diode (LED) lamp 9 in combination with pre-cleaning charging station 10 in order to electrostatically modify the surface potential of the non-image areas of the primary image member 1 and the charge on the waste toner remaining on the primary image member 1, respectively. In addition, a cleaning station 8 is included to physically remove any remaining waste toner particles. The cleaning station 8 is illustrated in FIG. 3 and is discussed in greater detail below.

A transfer nip is used between a transfer backer roller 7 and the intermediate transfer drum 5 to transfer the toner image to the receiving sheet 25. In a similar manner to that discussed above, the remaining waste toner particles that remain on the intermediate transfer drum 5 after the toner has been transferred to the sheet 25 are removed using a pre-cleaning charging station 12 and a cleaning station 11. Once again, the details of the cleaning station 11 are shown in FIG. 3 and are discussed below in detail. The receiving sheet 25 is transported by a dielectric conveyor 6 to a fuser 30 where the toner image is fixed by conventional means. The receiving sheet is then conveyed from the fuser 30 to an output tray 35.

The toner image is transferred from the primary image member 1 to the intermediate transfer drum 5 in response to an electric field applied between the core of drum 5 and a conductive electrode forming a part of primary image member 1. The toner image is transferred to the receiving sheet 25 at the nip in response to an electric field created between the backing roller 7 and the transfer drum 5. Thus, transfer drum 5 helps establish both electric fields. As is known in the art, a polyurethane roller containing an appropriate amount of anti-static material to make it of at least intermediate electrical conductivity can be used for establishing both fields. Typically, the polyurethane or other elastomer is a relatively thick layer; e.g., one-quarter inch thick, which has been formed on an aluminum base.

Preferably, the electrode buried in the primary image member 1 is grounded for convenience in cooperating with the other stations in forming the electrostatic and toner images. If the toner is a positively-charged toner, an electrical bias V_{ITM} applied to intermediate transfer drum 5 of typically −300 to −1,500 volts will effect substantial transfer of toner images to transfer drum 5. To then transfer the toner image onto a receiving sheet 25, a bias, e.g., of −2,000 volts or greater negative voltages, is applied to backing roller 7 to again urge the positively-charged toner to transfer to the receiving sheet. Schemes are also known in the art for changing the bias on drum 5 between the two transfer locations so that roller 7 need not be at such a high potential.

The ITM or drum 5 has a polyurethane base layer upon which a thin skin is coated or otherwise formed having the desired release characteristics. The polyurethane base layer preferably is supported upon an aluminum core. The thin skin may be a thermoplastic and should be relatively hard, preferably having a Young's modulus in excess of 5*10⁷ Newtons per square meter to facilitate release of the toner to ordinary paper or another type of receiving sheet. The base layer is preferably compliant and has a Young's modulus of 10⁷ Newtons per square meter or less to assure good compliance for each transfer.

With reference also now to FIG. 3, the cleaning apparatus 11 comprises a housing 32 which encloses the cleaning brush 34 having conductive fibers 36 which, through an opening in the housing, engage the ITM 2.

The brush 34 is supported on a core 35 which is driven in rotation by a motor M or other motive source to rotate in the direction of the arrow A as the ITM is moved in the direction shown by arrow B. As the brush rotates, untransferred toner particles 60 and other particulate debris, such as carrier particles and paper dust on the transfer drum 5, are mechanically scrubbed from the ITM and picked up into the fibers 36 of the brush. The items illustrated in the figures are generally not shown to scale to facilitate understanding of the structure and operation of the apparatus. In particular, the brush fibers are shown much larger to scale than other structures shown in FIG. 3.

In addition to mechanical scrubbing, an electrical bias is applied to the cleaning brush from power supply 39. The electrical bias V1 of the power supply 39 to the cleaning brush is, as will be more fully explained below, inductively, and not conductively, coupled to the conductive fibers or brush fibers 36. The voltage V1 is greater than the voltage bias V_{ITM} applied to the ITM. The polarity of the voltage on the brush fibers is such as to electrostatically attract toner 60 to the brush fibers. The toner particles 60 entrained within the fibers are carried to a rotating detoning roller 40 which is electrically biased by power supply 39 to a higher voltage level V2 than the voltage level V1; i.e., the voltage level V2 is of a level to electrostatically attract the toner particles in the brush to the detoning roller. Assuming a positively charged toner image, as an example, the toner image may be attracted to the ITM which is biased to the voltage bias V_{ITM} in the range of from about −300 volts to about −1500 volts. The cleaning brush, in such an example, would be biased to a potential V1 which is in the range of from about −550 volts to about −1750 volts. The detoning roller in this example would be biased to a potential V2 which is in the range of from about −800 volts to about −2000 volts. In considering relationships of voltage V2>V1>V_{ITM}, the absolute values of the voltages are implied.

The toner particles 60 are electrostatically attracted to the surface 41 of the detoning roller 40. The surface of detoning roller 40 is rotated in the direction of arrow C by a drive from motor M counter to that of the brush fibers or alternatively in the same direction. The toner particles are carried by the surface 41 of the detoning roller toward a stationary skive blade 42 which is supported as a cantilever at end 42a so that the scraping end 42b of the blade 42 engages the surface 41 of the detoning roller.

Toner particles scrubbed from the surface are allowed to fall into a collection chamber 51 of housing 32 and periodically a drive such as from motor M or another motive source, is provided to cause an auger 50, or another toner transport device, to feed the toner to a waste receptacle. Alternatively, the collection receptacle may be provided, attached to housing 32, so that particles fall into the receptacle directly and the auger may be eliminated. In order to ensure intimate contact between the detoning roller surface 41 and the skive blade 42, a permanent magnet is stationarily supported within the hollow enclosure of the detoning roller.

The skive blade is made of a metal such as ferromagnetic steel and is of a thickness of less than 0.5 mm and is magnetically attracted by the magnet to the detoning roller surface 41. This effectively minimizes the tendency of the blade end 42b to chatter as the surface 41 travels past the blade end 42b and thus provides more reliable skiving of the toner and, therefore provides, improved image reproduction. The skive blade extends for the full working width of the detoning roller surface 41 and is supported at its end 42b by ears 42c which are soldered to the blade. A pin extends through a hole in the ear portion to connect the skive to the housing.

The detoning roller 40 preferably comprises a toning or development roller as is used in known SPD-type development stations which include a core of permanent magnets surrounded by a metal sleeve 41a. As a detoning roller, the magnetic core is formed of a series of alternately arranged poles (north-south-north-south, etc.), permanent magnets 41b that are stationary when in operation. Sleeve 41a is formed of polished aluminum or stainless steel and is electrically conductive, but nonmagnetic, so as to not reduce the magnetic attraction of the skive blade to the magnets in the core. The sleeve is driven in rotation in the direction of arrow C and is electrically connected to potential V2.

As shown in FIG. 4, the invention monitors the operation of the different subsystems within the overall cleaning apparatus to monitor the cleaning apparatus performance. Therefore, the invention includes a number of sensors 115-119 (FIG. 3) that measure the operation of the different subsystems (individual elements) within the cleaner assembly. For example, with respect to the mechanical release function, one sensor will detect the interference between the brush and the substrate, and another sensor will detect whether rotational energy from the brush is reaching the substrate. Similarly, with respect to the transportation function in mechanical transport, a sensor measures the conveying function to the scavenging site by checking the rotation of the brush, and another sensor measures the physical capture of the particles in the fiber matrix. Also, with respect to the electrical transport, the sensors detect coulumbic attraction between waste material and brush fibers. With respect to the scavenging function, the invention detects how much waste is released from the fiber matrix due to the collision with the detone roller rotation, and by measuring magnetic forces between the waste and magnets in the detone roller. At the convey function (FIG. 4), the invention determines whether the skive physically removes waste from the detone roller surface, as well as whether gravity dispenses the waste into the auger tube. Finally, with respect to the collection function, the invention determines whether the cleaner is properly conveying waste (by means of gravity/auger) using a sensor in the waste bottle.

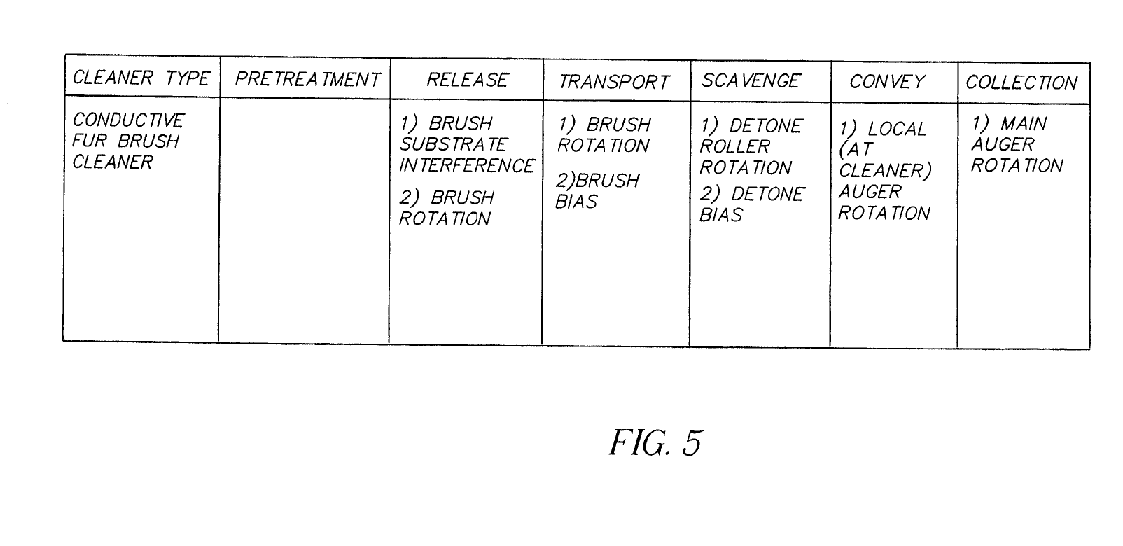

As similarly shown in FIG. 5, with respect to the release function, one sensor will detect whether the brush is contacting the substrate and whether the brush is rotating (FIG. 5). Similarly, with respect to the transportation function, the sensors detect brush rotation and brush bias. Also, with respect to the scavenging function (FIG. 5), the invention detects detone roller rotation as well as detone bias. At the convey function (FIG. 5), the invention determines whether there is local auger rotation. Finally, with respect to the collection function, the invention determines whether there is main auger rotation.

The actual implementation of the performance sensing can be quite variable depending on the configuration of the hardware. For example, the detection of the brush contacting the substrate could be implemented simply as an electrical switch on the cleaning apparatus that would actuate when the cleaning apparatus is placed in proper geometrical orientation with respect to the substrate, or as complex as optical or acoustic proximity sensors that accomplish the same function. Bias detection can be implemented as a closed loop system where the supply bias voltage to the cleaning apparatus is returned back to the power supply or another electrical circuit in which the supply voltage is compared to the returned voltage, and errors generate when the supply and return voltages do not match (within some tolerance band). This also provides a check for the presence of the conductive fur brush or detone roller in the cleaning apparatus in those hardware configurations that allow easy removal of those devices.

Bias detection could also be accomplished with more complex means, such as electrostatic voltage meters that measure the brush and detone voltage levels. Rotation sensing can be accomplished by a multitude of means, ranging from standard electromechanical methods, such as cams actuating electrical switches and hall effect sensors, to purely electrical means, such as sensing the current draw of the motor(s), to electromechanical/optomechanical methods such as optical encoders or resolvers. The sensors used generally have a specific function, such as rotation sensing and sensing to detect brush engagement to the substrate. The bias detection sensing also has a secondary benefit of detecting the presence of either the conductive fur brush or the detone roller.

Therefore, a proper cleaning function is determined by sensing the operation of the subsystems (e.g., release, transport, scavenge, convey, collection, etc.) within the cleaner assembly. Thus, the invention checks the rotation of the brush, detone roller, auger(s), etc. In addition, the invention checks for brush and detone bias voltage. Further, a sensor is used to detect proper spacing and orientation between the cleaner apparatus and the substrate. By observing the foregoing features, the invention does not require sophisticated sensors on the substrate to measure the effectiveness of the actual cleaning function.

While the invention has been described in terms of preferred embodiments, those skilled in the art will recognize that the invention can be practiced with modification within the spirit and scope of the appended claims.

### PARTS LIST

### Item Description

1 primary image member

2 transfer member

3 printhead

4 development station

5 transfer drum

6 dielectric conveyor

7 backing roller

8 cleaning station

9 lamp

11 cleaning station

12 charging station

15 imaging station

25 receiving sheet

30 fuser

32 housing

34 brush

36 fibers

39 power supply

40 detoning roller

41 surface

42 skive blade

42a blade end

60 toner particles

100 substrate

102 waste particles

106 collection media

108 scavenging system

110 auger tube

What is claimed is:

1. An image processing apparatus comprising:
an image transfer substrate;
a cleaner adjacent said substrate, wherein said cleaner removes contaminates from said substrate; and
sensors within said cleaner, wherein said sensors detect a position of said cleaner with respect to said substrate.

2. The image processing apparatus in claim 1, wherein if said sensors detect an improper position, an improper rotation, or an improper bias, said cleaner is rated unacceptable.

3. The image processing apparatus in claim 1, wherein said components include a fiber brush, a detone roller, and an auger.

4. The image processing apparatus in claim 3, wherein said fiber brush and said detone roller are biased to attract said contaminates.

5. The image processing apparatus in claim 3, further comprising a skive adapted to remove said contaminates from said detone roller.

6. The image processing apparatus in claim 5, wherein said auger transports said contaminates to a storage receptacle after said skive removes said contaminates from said detone roller.

7. The image processing apparatus in claim 1, wherein said sensors eliminate a need for sensors on said substrate.

8. An image processing apparatus comprising:
an image transfer substrate;
a cleaner adjacent said substrate, wherein said cleaner removes contaminates from said substrate; and
sensors within said cleaner, wherein said sensors detect a position of said cleaner with respect to said substrate, a proper rotation of components within said substrate, and a proper bias of said components.

9. The image processing apparatus in claim 8, wherein if said sensors detect an improper position, an improper rotation, or an improper bias, said cleaner is rated unacceptable.

10. The image processing apparatus in claim 8, wherein said components include a fiber brush, a detone roller, and an auger.

11. The image processing apparatus in claim 10, wherein said fiber brush and said detone roller are biased to attract said contaminates.

12. The image processing apparatus in claim 10, further comprising a skive adapted to remove said contaminates from said detone roller.

13. The image processing apparatus in claim 12, wherein said auger transports said contaminates to a storage receptacle after said skive removes said contaminates from said detone roller.

14. A method of image processing comprising the steps of:
providing an image transfer substrate;
placing a cleaner adjacent said substrate with sensors within said cleaner;
removing contaminates from said substrate with said cleaner; and
detecting, with said sensors, a relative position of said cleaner with respect to said substrate.

15. The method of claim 14, wherein said detecting step further comprises detecting a proper rotation of components with respect to said substrate.

16. The method of claim 15, wherein said detecting step further comprises detecting a proper bias of said components.

17. The method of claim 16, wherein said cleaner is rated unacceptable if said sensors detect an improper position, an improper rotation, or an improper bias.

18. The method of claim 15, wherein said detecting step further comprises detecting whether components, including a fiber brush, a detone roller, and an auger, are rotating properly.

19. The method of claim 18, wherein said providing step further comprises providing said fiber brush and said detone roller a bias to attract said contaminates.

20. A method of image processing comprising the steps of:
providing an image transfer substrate;
placing a cleaner adjacent said substrate with sensors within said cleaner;
removing contaminates from said substrate with said cleaner; and
detecting with said sensors a relative position of said cleaner with respect to said substrate, and
a proper bias of said components.

21. The method of claim 20, wherein said cleaner is rated unacceptable if said sensors detect an improper position, an improper rotation, or an improper bias.

22. The method of claim 20, wherein said detecting step further comprises detecting whether components, including a fiber brush, a detone roller, and an auger, are rotating properly.

23. The method of claim 20, wherein said providing step further comprises providing said fiber brush and said detone roller a bias to attract said contaminates.
